(19) United States
(12) Patent Application Publication
(10) Pub. No.: US 2012/0075768 A1
(43) Pub. Date: Mar. 29, 2012

(54) DIELECTRIC CERAMIC COMPOSITION AND MANUFACTURING METHOD THEREOF, AND CERAMIC ELECTRONIC DEVICE

(75) Inventors: Saori TAKEDA, TOKYO (JP); Fumiaki SATOH, TOKYO (JP); Jun SATO, TOKYO (JP); Masakazu HOSONO, TOKYO (JP)

(73) Assignee: TDK CORPORATION, TOKYO (JP)

(21) Appl. No.: 13/248,619

(22) Filed: Sep. 29, 2011

(30) Foreign Application Priority Data
Sep. 29, 2010 (JP) 2010-219775

(51) Int. Cl. H01G 4/30; C04B 35/64; C04B 35/468

(52) U.S. Cl. 361/301.4; 501/137; 264/614

(57) ABSTRACT

Dielectric ceramic composition comprising a compound having perovskite-type crystal structure and Y-oxide, and the compound is shown by a general formula ABO₃, where “A” is Ba alone or Ba and at least one selected from Ca and Sr, and “B” is Ti alone or Ti and Zr. The dielectric ceramic composition comprises dielectric particles including the above compound as a main component. When α=1000×(c/a)/d is defined, wherein “d [nm]” is an average particle diameter of raw material powders of the above compound and “c/a” is a ratio of lattice constants of c-axis and a-axis in a perovskite-type crystal structure of the raw material powders, “α” is 11.0 or less.

### BACKGROUND OF THE INVENTION

1. Field of the Invention

The present invention relates to a dielectric ceramic composition and manufacturing method thereof, and a ceramic electronic device. More precisely, the present invention relates to a dielectric ceramic composition showing an excellent temperature characteristic while maintaining a high specific permittivity and manufacturing method thereof, and a ceramic electronic device to which the dielectric ceramic composition is applied.

2. Description of the Related Art

Multilayer ceramic capacitor as an example of ceramic electronic device is widely used as a size-reduced electronic device showing a high performance and a high reliability; and a large number of the capacitors are used in electrical equipments and electronic equipments. In recent years, with the size-reduction and high performance of equipments, a demand for further reduction in size, higher performance and higher reliability of the ceramic electronic device is rapidly increasing.

In order to meet the demand, it has been attempted to improve characteristics of the capacitor obtained after firing, such as by controlling characteristics of raw material powders of dielectric ceramic composition constituting dielectric layers of ceramic capacitor.

For instance, Japanese unexamined patent publication No. 2008-285412 discloses barium titanate wherein its BET specific surface area and ratio of c-axis and a-axis in its crystal lattice are determined to have a specific relationship. According to the publication, it recites that the barium titanate has an excellent electrical characteristic.

However, the publication fails to describe specific electrical characteristic and therefore, it remained unclear if an excellent temperature characteristic of capacitance can be achieved.

### BRIEF SUMMARY OF THE INVENTION

The present invention has been made by considering the above circumstances, and a purpose of the present invention is to provide a dielectric ceramic composition showing an excellent temperature characteristic while maintaining a high specific permittivity and manufacturing method thereof, and a ceramic electronic device to which the dielectric ceramic composition is applied.

In order to achieve the above purpose, dielectric ceramic composition according to the present invention has a compound having perovskite-type crystal structure and Y-oxide. The compound is shown by a general formula ABO₃. Here, “A” is Ba alone or Ba and at least one selected from Ca and Sr, and “B” is Ti alone or Ti and Zr. The dielectric ceramic composition includes dielectric particles having the above compound as a main component. When α=1000×(c/a)/d is defined, where “d [nm]” is an average particle diameter of raw material powders of the above compound and “c/a” is a ratio of lattice constants of c-axis and a-axis in perovskite-type crystal structure of the raw material powders, “α” is 11.0 or less.

Generally, when an average particle diameter of raw material powders of the compound shown by ABO₃ is varied according to the desired characteristic, intended use, etc., temperature characteristic may be changed and maintenance of an excellent temperature characteristic is known to be quite difficult, and in some cases, specific permittivity may also change.

Therefore, the present invention introduces a new parameter “α” as mentioned above and limits its value within the abovementioned range. Consequently, even when an average particle diameter of raw material powders of the above compound is varied, an excellent temperature characteristic can be realized, while maintaining a high specific permittivity.

When defining an average crystal particle diameter of the above dielectric particles as “D [nm]” and grain growth rate [%]=(D/d)×100, the grain growth rate is preferably 100 to 140%.

Segregation region including the above Y-oxide preferably exists in the dielectric ceramic composition, and ratio of an area of the segregation region with respect to an area of the field of view of 200 μm² is preferably 0.1 to 5.0%.

This allows to improve effects of the invention.

Further, ceramic electronic device according to the present invention has a dielectric layer, constituted by one of the above dielectric ceramic composition, and an electrode.

Although the above ceramic electronic device is not particularly limited, multilayer ceramic capacitor, piezoelectric element, chip inductor, chip varistor, chip thermistor, chip resistor and the other surface mount chip electronic device (SMD) could be exemplified.

Also, a manufacturing method of dielectric ceramic composition according to the present invention is a manufacturing method of a dielectric ceramic composition including a compound having a perovskite-type crystal structure and a Y-oxide and the compound is shown by a general formula ABO₃. Here, “A” is Ba alone or Ba and at least one selected from Ca and Sr, and “B” is Ti alone or Ti and Zr. The manufacturing method includes a step of preparing a dielectric material having raw material powders of the above compound and a raw material of the Y-oxide, a step of obtaining a compact by forming the dielectric material and a step of firing the compact. Further, when α=1000×(c/a)/d is defined, where “d [nm]” is an average particle diameter of raw material powders of the above compound and “c/a” is a ratio of lattice constants of c-axis and a-axis in perovskite-type crystal structure of the raw material powder of the above compound, “α” is 11.0 or less. Furthermore, a temperature rising rate of the step of firing is 600 to 8000° C./hour.

### BRIEF DESCRIPTION OF THE DRAWINGS

FIG. 1 is a cross-sectional view of a multilayer ceramic capacitor according to an embodiment of the present invention.

FIG. 2 is a schematic view showing a state of existence of segregation region in cross-section of dielectric layer of the multilayer ceramic capacitor as shown in FIG. 1.

FIG. 3 is a graph showing a relation between content of a Y-oxide and temperature characteristic of capacitance.

### DETAILED DESCRIPTION OF THE INVENTION

Hereinafter, the present invention will be described based on embodiments shown in drawings.

(Multilayer Ceramic Capacitor 1)

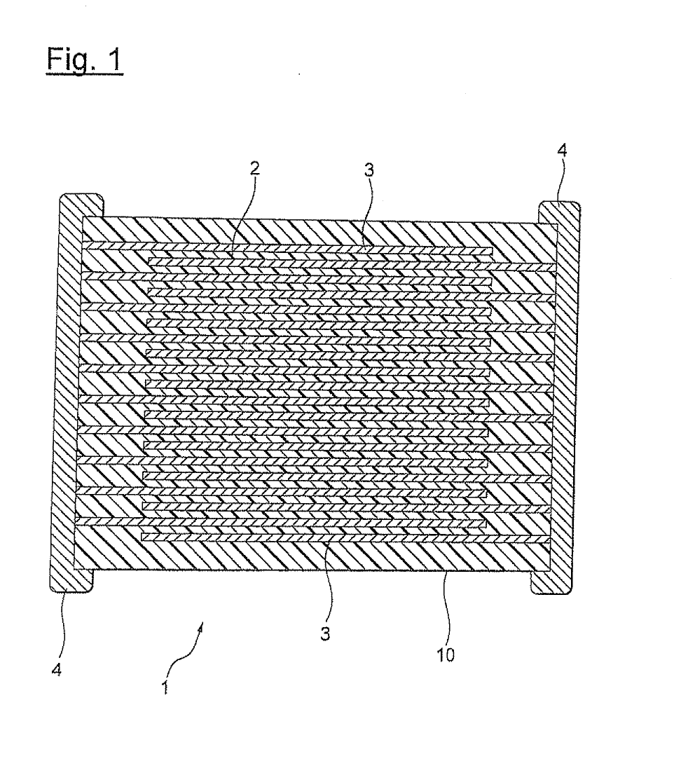

As is shown in FIG. 1, multilayer ceramic capacitor 1 of the present embodiment has a capacitor element body 10 in which dielectric layers 2 and internal electrode layers 3 are alternately stacked. The internal electrode layers 3 are stacked so that the end surfaces are alternately exposed to facing surfaces of the end portions of the capacitor element body 10. A pair of external electrodes 4 are connected to exposed end surfaces of internal electrode layers 3 so as to configure a capacitor circuit.

Although a shape of capacitor element body 10 is not particularly limited, it is generally a rectangular parallelepiped as is shown in FIG. 1. Further, its size is also not particularly limited and may be a suitable size according to its use.

(Dielectric Layer 2)

The dielectric layer 2 is constituted by a dielectric ceramic composition of the present embodiment. The dielectric ceramic composition has a compound shown by a general formula ABO₃ (“A” is Ba alone or Ba and at least one selected from Ca and Sr, and “B” is Ti alone or Ti and Zr) as a main component, and a Y-oxide as a subcomponent. Note that an amount of oxide (O) may be slightly deviated from stoichiometric composition.

The compound is specifically shown by a composition formula: (Ba_{1-x-y}CaₓSr_{y})(Ti₁₋ₘZrₘ)O₃ and has a perovskite-type crystal structure. The compound includes at least Ba as A site atom, and at least Ti as B site atom. Further, molar ratio of A site atom (Ba, Sr and Ca) and B site atom (Ti and Zr) is shown as A/B ratio. In the present embodiment, A/B ratio is preferably 0.98 to 1.02. In the present embodiment, x=y=m=0 is preferable in the above formula, namely the compound is preferably barium titanate.

Content of Y-oxide is preferably 0.2 to 1.5 moles, more preferably 0.3 to 1.5 moles in terms of Y₂O₃, with respect to 100 moles of ABO₃. By setting the content of Y-oxide within the above range, advantages of obtaining an excellent high-temperature load lifetime as well as temperature characteristic can be offered.

The dielectric ceramic composition of the present embodiment may further include the other subcomponent according to the desired characteristics.

For instance, the dielectric ceramic composition of the present embodiment may include an oxide of rare earth element (R-element) other than Y. Content of R-element oxide, in terms of R₂O₃, is preferably 0.2 to 2.0 moles, more preferably 0.3 to 1.5 moles with respect to 100 moles of ABO₃. By setting the content of R-element oxide within the above range, advantages of obtaining an excellent high-temperature load lifetime as well as temperature characteristic can be offered. R-element is at least one selected from Sc, La, Ce, Pr, Nd, Pm, Sm, Eu, Gd, Tb, Dy, Ho, Er, Tm, Yb and Lu.

The dielectric ceramic composition of the present embodiment may further include Mg oxide. Content of Mg oxide, in terms of MgO, is preferably 0.7 to 2.0 moles, more preferably 1.0 to 2.0 moles with respect to 100 moles of ABO₃. By setting the content of Mg oxide within the above range, advantages of preventing grain growth of dielectric particles as well as obtaining an excellent high-temperature load lifetime can be offered.

The dielectric ceramic composition of the present embodiment may further include a Ca oxide. Content of Ca oxide, in terms of CaO, is preferably 0 to 0.5 mole, more preferably 0 to 0.4 mole with respect to 100 moles of ABO₃. By setting the content of Ca oxide within the above range, advantages of obtaining a resistance to reduction when firing and of preventing grain growth of dielectric particles can be offered.

The dielectric ceramic composition of the present embodiment may further include a Mn oxide. Content of Mn oxide, in terms of MnO, is preferably 0.01 to 0.2 mole, more preferably 0.03 to 0.2 mole with respect to 100 moles of ABO₃. By setting the content of Mn oxide within the above range, an advantage of obtaining an excellent resistance to reduction when firing can be offered.

The dielectric ceramic composition of the present embodiment may further include an oxide including Si. Content of the oxide, in terms of SiO₂, is preferably 0.4 to 1.0 mole, more preferably 0.5 to 0.8 mole with respect to 100 moles of ABO₃. By setting the content of the oxide within the above range, an advantage of improving sintering ability can be offered. Note that, the oxide including Si may be a composite oxide of Si and the other metal element or may be SiO₂ alone.

(Segregation Region 20)

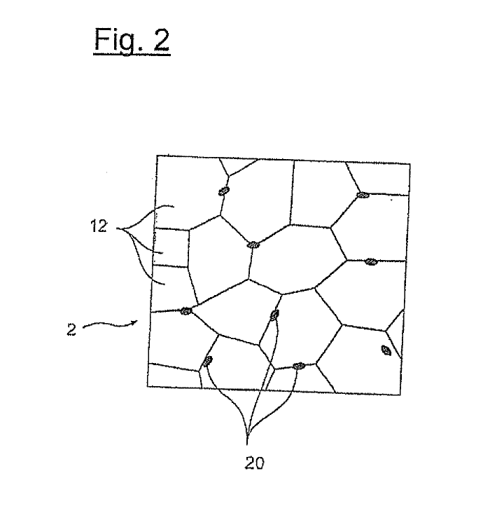

In the present embodiment, as is shown in FIG. 2, dielectric particles 12 and segregation region 20 including at least the Y-oxide exist in the dielectric layer 2. By controlling a state of existence of segregation region 20, an excellent temperature characteristic can be realized, while maintaining a high specific permittivity.

Dielectric particles 12 shown in FIG. 2 have ABO₃ as a main component. In the present embodiment, there may exist the other region (phase) besides dielectric particles 12 and segregation region 20. When an element besides the abovementioned Y is included as subcomponent, the element may be included in dielectric particles 12, segregation region 20 or the other regions.

“Segregation region including Y-oxide” indicates a region where concentration of Y is higher than that of the other regions. Therefore, elements constituting ABO₃ or elements of the other subcomponent may exist in the segregation region.

Whether or not segregation region including the Y-oxide exist may be assessed visually or with image processing or so by comparing contrast difference between segregation region and the other phase on scanning electron microscope (SEM) picture of cross-section of dielectric layer 2. Further, it is also possible to assess a mapping image of Y in specific region by means of energy dispersive X-ray spectrometer.

In the present embodiment, ratio of an area of segregation region with respect to an area of the field of view of 200 μm² occupied by dielectric layer (dielectric ceramic composition) is calculated. This ratio of the area is preferably 0.1 to 5.0%, more preferably, 0.3 to 2.2%, particularly preferably 0.8 to 2.2%. By setting the ratio of area of segregation region within the above range, it becomes easy to realize an excellent temperature characteristic, while maintaining a high specific permittivity.

Crystal particle diameter of the dielectric particles according to the present embodiment may be determined according to a thickness of dielectric layer 2 or so. Crystal particle diameter may be measured, for example, by a coding method as is described below. Namely, at first, capacitor element body 10 is cut in a plane parallel to stacking direction of dielectric layers 2 and internal electrode layers 3. Then border of dielectric particle in cross-section (the cut surface) is assessed and area of the particle is calculated. Diameter is calculated from this area as a circle-equivalent diameter. Crystal particle diameter is then determined by multiplying the calculated diameter by 1.27

Although it is not particularly limited as to how to calculate an average crystal particle diameter from the obtained crystal particle diameter, crystal particle diameters of 200 or more of dielectric particles may be measured and their average value may be determined as the average crystal particle diameter (D). The average crystal particle diameter (D) of dielectric particles in the present embodiment is preferably 120 to 200 nm.

The present embodiment further calculates a grain growth rate from an average particle diameter (d) of raw material powders of ABO₃ described hereinafter and an average crystal particle diameter (D) of the dielectric particles 12 included in the dielectric layer after firing. Specifically, it is calculated by the formula: grain growth rate (%)=(D/d)×100. Namely, grain growth rate shows a growth rate of particles of raw material powders after firing when an average particle diameter of raw material powders is considered to be 100%.

Grain growth rate in the present embodiment is preferably 100 to 140%. By setting the grain growth rate within the above mentioned range, an excellent temperature characteristic can be realized, while maintaining a high specific permittivity.

Although a thickness of dielectric layer 2 is not particularly limited and can be suitably determined according to the desired characteristic, its use, etc., in the present embodiment, 2.0 μm or less per a layer is preferable. Number of stacked layers of dielectric layer 2 is also not particularly limited and can be suitably determined according to its use.

(Internal Electrode Layer 3)

Although conducting material included in the internal electrode layer 3 is not particularly limited, relatively inexpensive base metal can be used when materials constituting dielectric layer 2 have a resistance to reduction. Ni or Ni alloy is preferable for base metal used for the conducting material. A thickness of the internal electrode layer 3 is not particularly limited and can be suitably determined according to its use.

(External Electrode 4)

Although conducting material included in the external electrode 4 is not particularly limited, inexpensive Ni, Cu or their alloys may be used in the invention. Although a thickness of external electrode 4 can be suitably determined according to its use, it is preferably around 5 to 50 μm in general.

(Manufacturing Method of the Multilayer Ceramic Capacitor 1)

The multilayer ceramic capacitor 1 of the present embodiment is manufactured by, as is the same with conventional multilayer ceramic capacitors, preparing green chip with normal printing method or sheet method using paste and firing the same, and then printing or transferring external electrode thereon and baking the same. The manufacturing method will specifically be described herein after.

Firstly, dielectric material for forming dielectric layer is prepared and then made to a paste in order to prepare a dielectric layer paste.

The dielectric layer paste may be either an organic paste, to which the dielectric material and an organic vehicle are kneaded, or a water-based paste.

As the dielectric material, a raw material powders of ABO₃ and raw materials of Y-oxide are first prepared. As the raw materials of Y-oxide, it is not only selected from oxides but also it is possible to suitably select from a variety of compounds to become Y-oxide after firing, for example, carbonate, oxalate, nitrate, hydroxide, organic metallic compound, etc., or a mixture thereof.

As the raw material powders of ABO₃, powders manufactured by various methods including not only so-called a solid-phase method but various kinds of liquid-phase method, such as oxalate method, hydrothermal synthesis method, alkoxide method, sol-gel method, etc., may be used.

Although particles included in raw material powders of ABO₃ have perovskite-type crystal structure, the perovskite-type crystal structure changes with temperature and they have tetragonal system at an ordinary temperature of Curie point or below while cubic system at Curie point or above. Lattice constants of each crystal axes (a-axis, b-axis and c-axis) in cubic system are equal, while lattice constant of an axis (c-axis) is longer than that of the other axes (a-axis b-axis)) in tetragonal system.

In the present embodiment, “c/a” showing a ratio of lattice constant of c-axis and that of a-axis of particles included in raw material powders of ABO₃ is preferably 1.007 or more, more preferably 1.008 or more.

Note that it is not necessary for “c/a” of all the particles in raw material powders to satisfy the above range. Namely, for example, when selecting a barium titanate powder as raw material powders of ABO₃, coexistence of tetragonal system type barium titanate particles and cubic system type barium titanate particles is possible and “c/a” would be within the above range as whole raw material powders.

Further, the average particle diameter of raw material powders can be measured by the following method. Namely, raw material powders are observed with SEM, and then an area of the particle is calculated from an outline of the particle. And a value of diameter calculated as a circle-equivalent diameter, is considered to be a diameter of the particles.

Although it is not limited as to how to calculate an average particle diameter of raw material powders from the obtained particle diameter, particle diameters of 500 or more of raw material powder particles may be measured and their average value may be determined as the average particle diameter (d). The average particle diameter (d) of raw material powders of ABO₃ in the present embodiment is preferably 80 to 200 nm.

Further, in the present embodiment, when α=1000×(c/a)/d is defined where “d” is an average particle diameter of raw material powders of ABO₃ and “c/a” is defined above, “α” satisfies α≦11.0, preferably satisfies, α≦9.

By setting “α” within the above mentioned range, even when the average particle diameter of raw material powders varies, an excellent temperature characteristic can be realized, while maintaining a high specific permittivity. For instance, by controlling grain growth of dielectric particles relative to average particle diameter of raw material powders, desired characteristic can be obtained. In addition, since it is possible to suppress grain growth of dielectric particles, sufficient reliability can be secured even when dielectric layer is made to a thin layer.

When components other than the abovementioned component are included in the dielectric layer, raw materials of the components are prepared. As for the materials, oxides of the components, their mixtures and their composite oxides may be used, as is the same with the above. Further, variety of compounds to become the above oxides or composite oxides after firing may also be used.

Content of each compound in the dielectric materials is determined in order for the dielectric ceramic composition after firing to become the abovementioned composition.

Organic vehicle is obtained by dissolving a binder in an organic solvent. The binder is not particularly limited and may be suitably selected from various kinds of normal binders such as ethyl cellulose, polyvinyl butyral, etc. The organic solvent is also not particularly limited and may be suitably selected from various kinds of organic solvent, such as terpineol, butyl carbitol, acetone, toluene, etc., according to a utilized method, such as printing method or sheet method.

Further, when the dielectric layer paste is a water-based paste, a water-based vehicle, which a water-soluble binder, dispersants, etc. are solved in water, and the dielectric material would be kneaded. The water-soluble binder used for water-based vehicle is not particularly limited, and for example, polyvinyl alcohol, cellulose, water-soluble acrylic resin, etc., may be used.

An internal electrode layer paste is prepared by kneading the conductive material constituted by various kinds of conductive metals, such as Ni, and alloys or various kinds of oxides which become the above-mentioned conductive material after firing, organic metal compounds, resinate, etc. with the abovementioned organic vehicle. The internal electrode layer paste may further include inhibitor. Although the inhibitor is not particularly limited, it is preferable to have the similar composition with the main component.

The external electrode paste is prepared as is the same with the above mentioned internal electrode layer paste.

Content of the organic vehicle in each paste mentioned above is not particularly limited, and may be a normal content, for example, around 1 to 5 wt % of the binder and around 10 to 50 wt % of the solvent. Also, each paste may include additives selected from a variety of dispersants, plasticizers, dielectrics, insulator, etc., if needed. Their total content is preferably 10 wt % or less.

When printing method is used, the dielectric layer paste and the internal electrode layer paste are printed on a substrate, such as PET, stacked, cut to a predetermined form and then removed from the substrate to obtain a green chip.

Also, when sheet method is used, a green sheet is formed with dielectric layer paste, the internal layer paste is printed thereon, and then, the results are stacked and cut to a predetermined form to obtain a green chip.

Binder removal treatment is performed to the green chip before firing. As for binder removal conditions, a temperature rising rate is preferably 5 to 300° C./hour, a holding temperature is preferably 180 to 400° C., and a temperature holding time is preferably 0.5 to 24 hours. The binder removal atmosphere is in the air or a reduced atmosphere.

The green chip is fired after removing the binder. When firing, a temperature rising rate is preferably 600 to 8000° C./hour, a holding temperature is preferably 1300° C. or less, more preferably 1000 to 1300° C., and a temperature holding time is preferably 0.2 to 3 hours.

Atmosphere when firing is preferably a reduced atmosphere. As for atmospheric gas, for example, a wet mixed gas of N₂ and H₂ is preferably used.

Although oxygen partial pressure when firing may be suitably determined in accordance with the type of conducting material in the internal electrode layer paste, when base metals such as Ni or Ni alloys are used for the conducting material, the oxygen partial pressure in firing atmosphere is preferably 10⁻¹⁴ to 10⁻¹⁰ MPa. Temperature lowering rate when firing is preferably 600 to 8000° C./hour.

After fired in a reduced atmosphere, it is preferable that an anneal is performed to the capacitor element body. The anneal is a process for re-oxidizing dielectric layer and high-temperature load lifetime is remarkably elongated thereby.

An oxygen partial pressure in annealing atmosphere is preferably 10⁻⁹ to 10⁻⁵ MPa. Re-oxidization of the dielectric layers becomes difficult when the oxygen partial pressure is lower than the abovementioned range, while oxidation of the internal electrode layers proceeds when exceeding the abovementioned range.

It is preferable that a holding temperature when annealing is 1100° C. or less, particularly 900 to 1100° C. The oxidation of the dielectric layer becomes insufficient when the holding temperature is lower than the above mentioned range; and that insulation resistance (IR) tends to become lower and high-temperature load lifetime tends to become short. While the internal electrode layer is oxidized and capacity is reduced when the holding temperature exceeds the abovementioned range. Note that the anneal may be composed only of the temperature rising step and a temperature lowering step. Namely, temperature holding time may be zero. In this case, the holding temperature is synonymous with the highest temperature.

As for the other annealing conditions, a temperature holding time is preferably 0 to 30 hours and the temperature lowering rate is preferably 50 to 500° C./hour. Also, for example, a wet N₂ gas or so is preferably used for atmospheric gas of the annealing.

In the above processes of removing binder, firing and annealing, for example, a wetter may be used to wet N₂ gas or the mixed gas or so. In this case, water temperature is preferably 5 to 75° C. or so.

The processes of removing binder, firing and annealing may be performed continuously or separately.

End surface polishing by barrel polishing or sand blast, etc. is performed on the capacitor element body obtained as above, and the external electrode paste is printed thereon and baked to form the external electrodes 4. A cover layer is then formed by plating, etc. on the surface of the external electrode 4, if necessary.

A multilayer ceramic capacitor of the present embodiment produced as above is mounted on a printed substrate, etc. by such as soldering, and used for a variety of electronic apparatuses, etc.

An embodiment of the present invention is explained above, but the present invention is not limited to the above embodiment and may be variously modified within the scope of the present invention.

In the above embodiment, a multilayer ceramic capacitor is explained as an example of ceramic electronic device according to the present invention, but ceramic electronic device according to the present invention is not limited to the multilayer ceramic capacitor and may be any as far as it includes the above constitution.

### EXAMPLES

Below, the present invention will be explained based on furthermore detailed examples, but the present invention is not limited to the examples.

### Example 1

As for raw material powders of ABO₃ as a main component, BaTiO₃ (BT) powder in which an average particle diameter and “c/a” are the values shown in Table 1 was prepared. As for raw materials of subcomponent, MgCO₃, MnCO₃, Y₂O₃, CaCO₃ and SiO₂ were prepared. Note that, as for a sample of Example 12, Ba_{0.95}Ca_{0.05}TiO₃ (BCT) powder was used for raw material powders of ABO₃. The average particle diameter and “c/a” of raw material powders of ABO₃ were obtained as below and “α” was calculated from the obtained values.

(Average Particle Diameter d)

Primary particles constituting raw material powders of ABO₃ were observed with SEM and its SEM picture was taken. Image processing of the SEM picture was performed by software and outlines of particles were determined and areas of each particle were calculated. Particle diameters were calculated from the calculated areas, considering the diameter to be a circle-equivalent diameter, and their average value was determined as an average particle diameter (d) of raw material powders of ABO₃. Note that calculation of particle diameter was performed on 500 of dielectric particles. Results are shown in Table 1.

(c/a)

X-ray diffraction was performed on raw material powders of ABO₃. Cu—Kα ray was used for X-ray source and their measured condition was under a voltage of 45 kV, 2θ=20° to 130°. Rietveld refinement was used with the obtained X-ray diffraction intensity by measurement to assess “c/a”. Results are shown in Table 1.

“α” was calculated from the above obtained average particle diameter (d) and “c/a” of raw material powders of ABO₃. The calculated “α” are shown in Table 1.

Next, 100 parts by weight of a total (dielectric material) including the above prepared ABO₃ raw material powders and subcomponent raw materials, 10 parts by weight of polyvinyl butyral resin, 5 parts by weight of dioctylphthalate (DOP) as a plasticizer and 100 parts by weight of alcohol as a solvent were mixed by a ball mill to form a paste so as to obtain a dielectric layer paste.

Note that an additive amount of each subcomponent was determined so as to make a total content of subcomponents in dielectric layer after firing becomes 3.75 moles with respect to 100 moles of ABO₃, the main component. Further, a content of Y₂O₃, in terms of Y₂O₃, was determined to be the amount shown in Table 1. Also, MgCO₃, MnCO₃ and CaCO₃ were included in the dielectric ceramic composition as MgO, MnO and CaO, after firing.

44.6 parts by weight of Ni powder, 52 parts by weight of terpineol, 3 parts by weight of ethyl cellulose and 0.4 part by weight of benzotriazole were kneaded by a triple-roll to form a slurry, and an internal electrode layer paste was obtained.

The above obtained dielectric layer paste was used to form a green sheet on a PET film. Next, an electrode layer was printed thereon in a predetermined pattern by using the internal electrode layer paste, then the sheet was removed from PET film to manufacture the green sheet having the electrode layer. Then a plural number of green sheets having the electrode layer were stacked and adhered by pressure so as to obtain a green stacked body. The green stacked body was then cut to a predetermined size to obtain a green chip.

Next, processes of removing binder, firing and annealing were performed on the obtained green chip under the following conditions and an element body as a sintered body was obtained.

The binder removal process was performed under a condition that a temperature rising rate of 25° C./hour, a holding temperature of 260° C., a holding time of 8 hours, and the atmosphere of air.

The firing process was performed under a condition that a temperature rising rate of 600° C./hour, a holding temperature of 1190 to 1260° C. and holding time of 2 hours. The temperature lowering rate was as is the same with the temperature rising rate. Note that atmospheric gas was a wet mixed gas of N₂+H₂ where oxygen partial pressure was 3.8×10⁻⁹ MPa.

The annealing process was performed under a condition that a temperature rising rate of 200° C./hour, a holding temperature of 1000 to 1100° C., a holding time of 2 hours, temperature lowering rate of 200° C./hour, atmospheric gas of a wet N₂ gas where oxygen partial pressure was 1.4×10⁻⁴ MPa.

Note that a wetter was used to wet the atmospheric gas when firing and annealing.

Next, after polishing end faces of the obtained element body by sand blast, In—Ga as an external electrode was printed thereon and a multilayer ceramic capacitor sample having the configuration shown in FIG. 1 was obtained. A size of the obtained capacitor sample was 2.0 mm×1.25 mm×0.4 mm, a thickness of one dielectric layer was about 1.0 μm, and a thickness of one internal electrode layer was about 1.0 μm. A number of dielectric layers sandwiched between internal electrode layers was 4.

Ratio of area of segregation region, specific permittivity, temperature characteristic of capacitance and grain growth rate of the obtained capacitor samples were measured by the following methods.

(Ratio of Area of Segregation Region)

First, capacitor samples were cut at a surface perpendicular to the dielectric layer. Then SEM observation and EDX analyses were performed on the cut surface and a mapping image of Y was obtained. Image processing of the obtained mapping image was performed by software and ratio of an area of segregation region including Y, with respect to an area of the filed of view of 200 μm² occupied by dielectric layer, was calculated. Results are shown in Table 1.

(Specific Permittivity ∈)

For the capacitor sample, capacitance at reference temperature of 25° C. was measured with digital LCR meter (4274A by YHP) under the conditions of frequency at 1 kHz and input signal level (measured voltage) at 1.0 Vrms, and then, specific permittivity c (no unit) was calculated from the capacitance. Higher specific permittivity is preferable and 1000 or more were determined as “good” in the present examples. Results are shown in Table 1.

(Temperature Characteristic of Capacitance)

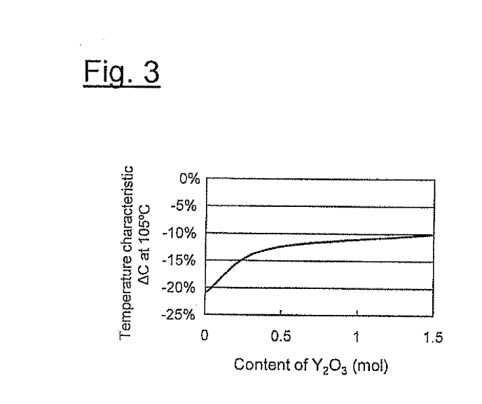

For the capacitor sample, capacitance at reference temperature of 25° C. was measured with digital LCR meter (4274A by YHP) under the conditions of frequency at 1 kHz and input signal level (measured voltage) at 0.5 Vrms, then capacitance at 105° C. was subsequently measured. Then change rate ΔC of capacitance at 105° C. was calculated to the capacitance at reference temperature of 25° C. It was evaluated whether the change rate ΔC is within ±15% or not. Results are shown in Table 1. In addition, FIG. 3 shows a graph indicating a relation between content of Y-oxide and temperature characteristic.

(Grain Growth Rate)

Capacitor samples were cut, and the cut surfaces were observed by SEM and their SEM pictures were taken. Image processing of these SEM pictures were performed by software and then border of dielectric particles were assessed and areas of each dielectric particles were calculated. Crystal particle diameter was calculated from these areas as a circle-equivalent diameter. An average value of the obtained diameters were determined to be an average crystal particle diameter. Note that calculation of crystal particle diameter was performed on 200 of dielectric particles. Results are shown in Table 1.

TABLE 1

| | Raw material powders of ABO₃ | | | | | Characteristics | | | | |
|---|---|---|---|---|---|---|---|---|---|---|
| | | An | | | | | | | | Ratio of an |
| | | average | | | | | Grain growth | | Temperature | area of |
| | | particle | | | | An average crystal | rate | Specific | characteristic | segregation |
| | | diameter d | | | Y₂O₃ | particle diameter D | (D/d) × 100 | permittivity | ΔC [%] | region |
| Sample No. | c/a | [nm] | α | Types | [mol] | [nm] | [%] | εs | at 105° C. | [%] |
| Ex. 1 | 1.0096 | 198 | 5.10 | BT | 1.5 | 199 | 101 | 2083 | −10.2 | 2.02 |
| Ex. 2 | 1.0096 | 146 | 6.92 | BT | 1.5 | 153 | 105 | 1916 | −12.0 | 1.47 |
| Ex. 3 | 1.0092 | 143 | 7.06 | BT | 1.5 | 157 | 110 | 1635 | −11.6 | 1.42 |
| Ex. 4 | 1.0097 | 130 | 7.77 | BT | 1.5 | 152 | 117 | 1649 | −11.3 | 1.20 |
| Ex. 5 | 1.0085 | 121 | 8.33 | BT | 1.5 | 150 | 124 | 2003 | −12.9 | 1.01 |
| Ex. 6 | 1.0093 | 121 | 8.34 | BT | 1.5 | 143 | 118 | 1480 | −12.3 | 1.01 |
| Ex. 7 | 1.0094 | 118 | 8.55 | BT | 1.5 | 151 | 128 | 1880 | −13.6 | 0.93 |
| Ex. 8 | 1.0074 | 113 | 8.92 | BT | 1.5 | 142 | 126 | 1617 | −11.8 | 0.81 |
| Ex. 9 | 1.0090 | 96 | 10.51 | BT | 1.5 | 126 | 131 | 1691 | −14.9 | 0.33 |
| Comp. Ex. 1 | 1.0086 | 89 | 11.33 | BT | 1.5 | 146 | 164 | 1803 | −17.7 | 0 |
| Comp. Ex. 2 | 1.0081 | 116 | 8.69 | BT | 0 | 152 | 131 | 1461 | −21.7 | 0 |
| Ex. 10 | 1.0085 | 121 | 8.33 | BT | 0.4 | 151 | 125 | 1619 | −13.5 | 1.01 |
| Ex. 11 | 1.0085 | 121 | 8.33 | BT | 0.2 | 150 | 124 | 2236 | −14.8 | 0.34 |
| Ex. 12 | 1.0102 | 200 | 5.05 | BCT | 1.35 | 202 | 101 | 1770 | −6.3 | 1.83 |

“BT” indicates BaTiO₃ and “BCT” indicates (Ba,Ca)TiO₃
Content of Y₂O₃ is a content with respect to 100 moles of AB0₃

From Table 1, it was confirmed that high specific permittivity can be obtained while realizing excellent temperature characteristic when “α” is within the range of the invention and, in addition, Y-oxide is included. It was also confirmed that high specific permittivity can be obtained while realizing excellent temperature characteristic by making grain growth rate and ratio of area of segregation region within the abovementioned range.

To the contrary, it was confirmed that when “α” is without the range of the invention (comparative example 1) or when Y-oxide is not included (comparative example 2), they have inferior temperature characteristics.

From FIG. 3, it was confirmed that excellent temperature characteristic can be obtained by increasing content of Y₂O₃.

1. A dielectric ceramic composition comprising a compound having a perovskite-type crystal structure and a Y-oxide, and the compound is shown by a general formula ABO₃, where “A” is Ba alone or Ba and at least one selected from Ca and Sr, and “B” is Ti alone or Ti and Zr,
wherein
the dielectric ceramic composition comprises a dielectric particle including the compound as a main component; and
when α=1000×(c/a)/d is defined, where “d [nm]” is an average particle diameter of a raw material powder of the compound and “c/a” is a ratio of lattice constants of c-axis and a-axis in a perovskite-type crystal structure of the raw material powders, “α” is 11.0 or less.

2. The dielectric ceramic composition as set forth in claim 1, wherein a grain growth rate is 100 to 140% when defining an average crystal particle diameter of the dielectric particle as “D [nm]” and the grain growth rate [%]=(D/d)×100.

3. The dielectric ceramic composition as set forth in claim 1, wherein a segregation region including the Y-oxide exists in the dielectric ceramic composition and a ratio of an area occupied by said segregation region with respect to an area of the filed of view of 200 μm² is 0.1 to 5.0%.

4. The dielectric ceramic composition as set forth in claim 2, wherein a segregation region including the Y-oxide exists in the dielectric ceramic composition and a ratio of an area occupied by said segregation region with respect to an area of the filed of view of 200 μm² is 0.1 to 5.0%.

5. A ceramic electronic device comprising a dielectric layer, constituted from the dielectric ceramic composition as set forth in claim 1, and an electrode.

6. A manufacturing method of a dielectric ceramic composition comprising a compound having a perovskite-type crystal structure and a Y-oxide, wherein, the compound is shown by a general formula ABO₃ where “A” is Ba alone or Ba and at least one selected from Ca and Sr, and “B” is Ti alone or Ti and Zr,
comprising steps of;
preparing a dielectric material comprising a raw material powder of the compound and a raw material of the Y-oxide,
obtaining a compact by forming said dielectric material, and
firing the compact;
wherein when α=1000×(c/a)/d is defined, where “d [nm]” is an average particle diameter of the raw material powder of the compound and “c/a” is a ratio of lattice constants of c-axis and a-axis in a perovskite-type crystal structure of the raw material powder of the compound, “α” is 11.0 or less; and
a temperature rising rate in the step of firing is 600 to 8000° C./hour.
